(19) United States
(12) Patent Application Publication
(10) Pub. No.: US 2004/0203619 A1
(43) Pub. Date: Oct. 14, 2004

(54) Anoymous messaging using mobile telephone

(76) Inventor: Phillippe Tissot, Paris (FR)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/258,741

(22) PCT Filed: Apr. 5, 2001
(86) PCT No.: PCT/FR01/01032

(30) Foreign Application Priority Data
Apr. 26, 2000 (FR) 0005302

(51) Int. Cl. H04M 11/10; H04M 3/42

(52) U.S. Cl. 455/412.1; 455/414.1

(57) ABSTRACT

The invention concerns a method enabling users (4a, 4b) of mobile telephones (5, 6) to exchange messages anonymously using simple instructions. The method comprises steps which consist in: storing in a database (2) of a router-server (1) alias names representing the users (4a, 4b) and telephone addresses of the mobile telephones (5, 6) of the users (4a, 4b); sending to an addressee user (4b) a message prepared by a sender user (4a); replying to the sender user (4a) by sending him a message prepared by the addressee user (4b). The addressee user (4b) receives the message sent by the sender user (4a) without the latter revealing his identity and/or knowing the identity of the addressee user, nor using textual instructions to send the message.

This invention concerns a method enabling users of mobile telephones to exchange text or audio messages anonymously by using simple commands that do not require the use of keywords.

Internet-type communications networks are currently used for exchanging text messages. The technologies used are of the forum or chat or e-mail types.

The text messages are beginning to appear on mobile telephones. the users of mobile telephones can anonymously exchange messages by using easy-to-use commands. They also appreciate the opportunity to get together in discussion forums on the basis of subject, geography or demographics. In addition, anonymity is indispensable to maximum expansion of the interest group.

As a result, it is necessary to have tools available that enable the creation, transmission to a server and searching of ‘aliases’ that the mobile telephone user uses to assure his anonymity.

Further, in the domain of the mobile telephone, it is also desirable to be able to exchange voice messages or data (images, pictograms, photos, etc.) as well as text messages.

Today, in order to exchange messages between anonymous users on a mobile telephone network, a GSM subscriber has the sole solution of being familiar with the send procedures specific to anonymous message services, in particular the SMS (Short Message System).

The procedures specific to the anonymous message system are complex and hardly intuitive. They use keywords (or commands) that are inserted in the message text (send, list, group, etc.). These keywords are interpreted by the specific server.

The result is that the mobile telephone anonymous messaging system is used only by a very small number of subscribers, who are capable of memorizing the commands and their functions. Likewise, few telecommunications providers offer this type of service due to the fact of its complexity for the end user.

The solution according to the invention assures anonymity while simplifying message exchange procedures.

The invention relates to a method enabling the users of mobile telephones to exchange text or audio messages anonymously by using simple commands not requiring the use of keywords.

The method comprises the following steps:

It comprises the step (I) of sending a test or an audio message created by a sender user to an addressee user.

It further comprises the step (II) of responding to the sender user by addressing a response message created by the addressee user.

Step (I) of sending a text or an audio message created by a sender user to an addressee user is itself comprised of a plurality of steps.

It comprises the step (Ia) of memorizing aliases designating the users in a database of a router-server as well as the telephone addresses of the users' mobile telephones.

It further comprises the step (Ib) of inserting, by means of the sender user's mobile telephone, the addressee user's alias into a text message linked to the text or audio message.

It further comprises the step (Ic) of transmitting, by means of the sender user's mobile telephone, the text message to the server-router together with the text or audio message.

It further comprises the step (Id), for the server-router, of detecting the presence of an alias in the text message and searching in the database for the telephone address of the addressee user's mobile telephone.

It further comprises the step (Ie), for the server-router, of routing the text message as well as the message text to the mobile telephone of the addressee user.

Thus, the addressee user receives the text message sent by the sender user without the latter:

disclosing his identity and/or not knowing the identity of the addressee user;

not using text commands for sending the text or audio message.

Preferably, the step (Ia) of memorizing in a server-router database the aliases designating the users as well as the telephone addresses of the users includes the step, for the user concerned, of transmitting his alias to the server-router, in particular at the time of establishing the initial connection or also by web, e-mail, or DTMF.

In a first embodiment the alias is composed by adding a marker to a word such as, in particular, an asterisk *.

Thus, for example, the message “*Gilles. You have a meeting with Phillip on Monday.” will be interpreted by the server-router as containing the instruction to send the message to the telephone address belonging to the alias *Gilles.

In a second embodiment of the invention, the alias is defined by its position in the message, in particular, the initial position.

Thus, for example, the message: “Gilles Christian You have a meeting with Phillip on Monday” will be interpreted by the server-router as containing the instruction to send the message to the telephone address belonging to the alias Gilles and Christian. In fact, Gilles and Christian are the aliases found in the server-router database and are arranged at the beginning of the message.

Preferably, the step (Ia) of memorizing in a server-router database the aliases designating the users as well as their telephone addresses of the users' mobile telephones includes the step of memorizing the identifiers and/or the alias of a group as well as the address of the server containing the group and/or the telephone addresses of the group members' mobile telephones.

Thus, the messages are routed directly or indirectly by the server-router to the users who are members of the group.

The method is characterized by the fact that the step (II) of responding to the sender user by addressing a reply message created by the addressee user is comprised of a plurality of steps:

It is comprised of the step (IIa) of memorizing on the server-router the telephone address of the sender user's mobile telephone as well as addressee user's telephone address.

It further comprises the step (IIb) of memorizing in the addressee user's mobile telephone the server-router's telephone address.

Thus, by actuating the “reply” command from his mobile telephone (cf. note), the addressee user causes transmission of the reply message that he created to the server-router, which routes the reply message to the sender user's mobile telephone, while preserving the anonymity of both the sender user and the addressee user. Note: It is recalled that mobile telephones have a “reply” command, which, when actuated, effects the transmission of a reply message to the telephone address of the sender of the original message.

The method according to the invention is more particularly intended to enable an addressee user to reply to several sender users who have sent one or a plurality of messages.

The method is characterized by the fact that in order to transmit to the addressee user originating with different sender users, the server-router uses output telephone addresses that are different for each sender user.

The method is further characterized by the fact that the server-router stores the telephone addresses of the sender users of the messages it routes by allocating a defined memory area for each output telephone address.

Thus, by actuating the “ireply” command, the addressee user effects the transmission of the reply message that he has created to the output telephone address. The server-router then routes the reply message to the sender user of the original message.

Preferably, the server-router stores the sender address of the sender user of the last message that it routes via a particular output telephone address.

Thus, in the case, wherein the number of messages addressed to an addressee user is greater than the number of output addresses of the router-server, the sender users who will be eliminated are those who, for a particular output address, are the oldest.

In a first embodiment, the method is characterized by the fact that the server-router deletes the telephone addresses of the sender users to which the addressee user has not responded for a defined period of time.

Thus, in the case wherein the number of messages addressed to an addressee user is greater than the number of output telephone addresses of the server-router, the sender users who will be eliminated are those occurring before a predefined date.

In a second embodiment, the method is characterized by the fact that the server-router deletes the telephone address of the oldest sender user to whom the addressee user has not replied.

Thus, in the case wherein the number of messages addressed to the addressee user is greater than the number of output telephone addresses of the server-router, the sender users who will be eliminated are those with the oldest historical precedence.

In a third embodiment, the method is characterized by the fact that the server-router deletes the telephone address of the sender user to whom the addressee user has replied.

Thus, the server-router releases output telephone addresses.

The method is more particularly intended to enable an addressee user who is a forum member to receive messages from the forum and to reply to them.

The method is characterized in that in order to transmit messages coming from a forum to an addressee user the server router uses a common output telephone address for all of the forum messages.

Thus, all of the incoming and outgoing messages between the particular members passed via a unique telephone address and use as the addressee user either the addressee user (forum member), if they are coming from the server, or the forum, if they are coming from the addressee user.

Preferably, the output telephone addresses of the server-router are present in particular in the form of multiplexing channels.

Preferably, for anonymous exchange of audio messages, the method comprises a plurality of steps.

It comprises the step of sending in DTMF mode the alias of the addressee user or that of the forum group.

It further comprises the step of transmitting the alias in DTMF mode a voice server-router.

Preferably, to transmit the alias of the addressee user or the forum group in DTMF mode the method comprises a plurality of steps.

It comprises the step of sending an alias send request in DTMF mode to the mobile telephone of the sender user using the voice server-router.

It further comprises the step of entering, by means of the sender user's mobile telephone keypad, the first letter of the alias of the addressee user and then continuing.

Thus, for example, the alias “music” will be entered by the sender user in DTMF mode by using the keys with the numbers: 68745 in succession.

The invention also relates to a system enabling users of mobile telephone to exchange text or audio messages anonymously by using simple commands that do not require the use of keywords.

The system includes the memorizing means for memorizing the aliases designating the users as well as the mobile telephone telephone addresses in a database of a server-router.

The system further includes the transmission means for sending a text or audio message created by a sender user to an addressee user.

The system further includes the reply means for addressing to a sender user a reply message created by the addressee user.

The transmission means for sending to an addressee user a text or audio message created by a sender user, comprise insertion means for inserting the alias of the addressee user in the message text linked to the text or audio message.

The transmission means further include transmission means for transmitting the message text to the server-router as well as the text or audio message.

The server-router includes detection means for detecting in the message text the presence of an alias and searching in the database for the telephone address of the addressee user's mobile telephone.

The server-router further includes routing means for routing the message text as well as the text message to the addressee user's mobile telephone.

Thus, the addressee user receives the text message sent by the sender user without:

disclosing his identity and/or knowing the identity of the addressee user,

using text commands to effect sending of the text or audio message.

Preferably, in order to store the aliases designating the users as well as the telephone addresses of the user's mobile telephones in the database of a server-router, the particular user's mobile telephone includes the transmission means for transmitting his alias to the server-router, particularly at the time of the first connection or likewise by web, e-mail or DTMF.

In a first embodiment, the alias is composed by adding to a word a marker such as, in particular, an asterisk *.

Thus, for example, the message: “*Gilles. You have a meeting with Phillip on Monday” will be interpreted by the server-router as containing the instruction to send the message to the telephone address belonging to the alias *Gilles.

In a second embodiment, the alias is defined by its position in the message, in particular at the beginning.

Thus, for example, the message: “Gilles Christian You have a meeting with Phillip on Monday” will be interpreted by the server-router as containing the instruction to send the message to the telephone addresses belonging to the aliases Gilles and Christian. In fact, Gilles and Christian are the aliases found in the database of the server-router and are arranged at the beginning of the message.

Preferably, the memorizing means memorizing the identifiers and/or the alias of a group as well as the addresses of the server containing the group and/or the mobile telephone addresses of the users who are members of the group.

Thus, the messages are routed directly or indirectly by the server-router to the users who are members of the group.

For transmitting the reply message created by the addressee user to the sender user, the system includes the server-router memorizing means for memorizing on the server-router the telephone address of the sender user's mobile telephone as well as the telephone address of addressee user's mobile telephone.

The system further includes the mobile telephone memorizing means for memorizing in the addressee user's mobile telephone the telephone address of the server-router.

Thus, by actuating the “reply” command from his mobile telephone (cf. note), the addressee user causes transmission of the reply message that he created to the server-router, which routes the reply message to the sender user's mobile telephone, while preserving the anonymity of both the sender user and the addressee user. Note: It is recalled that mobile telephones have a “reply” command, which, when actuated, effects the transmission of a reply message to the telephone address of the sender of the original message.

The system is more particularly intended to enable an addressee user to reply to several sender users who have sent one or a plurality of messages.

The system is such that the server-router includes a plurality of output telephone addresses, the calculation means for allocating different output telephone addresses for each sender user and memorization means for memorizing the telephone addresses of the sender users of messages it routes, by allocating a defined memory area for each output telephone address.

Thus, by actuating the “reply” command, the addressee user effects the transmission of the reply message that he has created to the output telephone address of the server router associated with the telephone address of the sender user. The server-router then routes the reply message to the sender user of the original message.

Preferably, the memorizing means of the server-router stores the telephone address of the sender user of the last message that it routes via a particular output telephone address.

Thus, in the case wherein the number of messages addressed to an addressee user is greater than the number of output telephone addresses of the router-server, the sender users who will be eliminated are those who, for a particular output address, are the oldest in historical precedence.

In a first embodiment, the server-router has the means for deleting the telephone addresses of the sender users to which the addressee user has not responded for a defined period of time.

Thus, in the case wherein the number of messages addressed to an addressee user is greater than the number of output telephone addresses of the server-router, the sender users who will be eliminated are those occurring before a predefined date.

In a second embodiment, the server-router has the means for deleting the telephone address of the oldest sender user to whom the addressee user has not replied.

Thus, in the case wherein the number of messages addressed to the addressee user is greater than the number of output telephone addresses of the server-router, the sender users who will be eliminated are those with the oldest historical precedence.

In a third embodiment, server-router has the means for deleting the telephone address of the sender user to whom the addressee user has replied.

Thus, the server-router releases output telephone addresses.

The system according to the invention is more particularly intended to enable an addressee user who is a forum member to receive messages from the forum and to reply to them.

The system is characterized in that in order to transmit messages coming from a forum to an addressee user the server router uses a common output telephone address for all of the forum messages.

Thus, all of the incoming and outgoing messages between the forum and the particular member pass via a unique telephone address and use as the addressee user either the addressee user (forum member), if they are coming from the server, or the forum, if they are coming from the addressee user.

Preferably, the output telephone addresses of the server-router are present in particular in the form of multiplexing channels.

Preferably, for anonymous exchange of audio messages, the mobile telephones have transmitting means for transmitting in DTMF mode the alias of the addressee user or that of the forum group.

The mobile telephones further comprise the transmitting means for transmitting the alias in DTMF mode to a voice server-router.

Preferably, to transmit the alias of the addressee user or that of the forum group in DTMF mode the voice server-router includes the transmitting means for sending a send request for the alias in DTMF mode to the sender user's mobile telephone.

Likewise, for sending the alias of the addressee users or that of the forum group in DTMF mode, the mobile telephone includes data entry means, in particular a keypad.

Thus, the sender user can enter, using the mobile telephone keypad, the first letter of the alias of the addressee user and so on.

Thus, for example, the alias “musik” will be entered by the sender user in DTMF mode by using the keys with the numbers: 68745 in succession.

The invention also relates to a server-router enabling users of mobile telephone to exchange text or audio messages anonymously by using simple commands that do not require the use of keywords.

The server-router includes the memorizing means for memorizing the aliases designating the users as well as the mobile telephone telephone addresses in a database of a server-router.

The sender user sends to an addressee user a text or audio message including the addressee user's pseudo.

The addressee user then addresses a reply message to the sender user.

The system further includes the receiving means for receiving the message text as well as the text or audio message.

The server-router includes detection means for detecting in the message text the presence of an alias and searching in the database the telephone address of the addressee user's mobile telephone.

The server-router further includes routing means for routing the message text as well as the text message to the addressee user's mobile telephone.

Thus, the addressee user receives the text message sent by the sender user without:

disclosing his identity and/or knowing the identity of the addressee user,

using text commands to effect sending of the text or audio message.

Preferably, in order to store the aliases designating the users as well as the telephone addresses of the user's mobile telephones in the database of a server-router, the particular user's mobile telephone includes the transmission means for transmitting his alias to the server-router, particularly at the time of the first connection or likewise by web, e-mail or DTMF.

In a first embodiment, the alias is composed by adding to a word a marker such as, in particular, an asterisk *.

Thus, for example, the message: “*Gilles. You have a meeting with Phillip on Monday” will be interpreted by the server-router as containing the instruction to send the message to the telephone address belonging to the alias *Gilles.

In a second embodiment, the alias is defined by its position in the message, in particular at the beginning.

Thus, for example, the message: “Gilles Christian You have a meeting with Phillip on Monday” will be interpreted by the server-router as containing the instruction to send the message to the telephone addresses belonging to the aliases Gilles and Christian. In fact, Gilles and Christian are the aliases found in the database of the server-router and are arranged at the beginning of the message.

Preferably, the memorizing means memorizing the identifiers and/or the alias of a group as well as the addresses of the server containing the group and/or the mobile telephone addresses of the users who are members of the group.

Thus, the messages are routed directly or indirectly by the server-router to the users who are members of the group.

Preferably, the server-router is characterized by the fact that it comprises memorizing means for memorizing the telephone addresses of the sender user's mobile telephone as well as the telephone address of the addressee user's mobile telephone. The addressee user's mobile telephone memorizes the telephone address of the server router.

Thus, by actuating the “reply” command from his mobile telephone (cf. note), the addressee user causes transmission of the reply message that he created to the server-router, which routes the reply message to the sender user's mobile telephone, while preserving the anonymity of both the sender user and the addressee user. Note: It is recalled that mobile telephones have a “reply” command, which, when actuated, effects the transmission of a reply message to the telephone address of the sender of the original message.

The server-router according to the invention is more particularly intended to enable an addressee user to reply to several sender users who have sent one or a plurality of messages to him.

The server-router is such that the server-router includes a plurality of output telephone addresses, the calculation means for allocating different output telephone addresses for each sender user and memorization means for memorizing the telephone addresses of the sender users of messages it routes, by allocating a defined memory area for each output telephone address.

Thus, by actuating the “reply” command, the addressee user effects the transmission of the reply message that he has created to the output telephone address of the server router associated with the telephone address of the sender user. The server-router then routes the reply message to the sender user of the original message.

Preferably, the memorizing means of the server-router stores the telephone address of the sender user of the last message that it routes via a particular output telephone address.

Thus, in the case, wherein the number of messages addressed to an addressee user is greater than the number of output telephone addresses of the router-server, the sender users who will be eliminated are those who, for a particular output address, are the oldest in historical precedence.

In a first embodiment, server-router has the means for deleting the telephone addresses of the sender users to which the addressee user has not responded for a defined period of time.

Thus, in the case wherein the number of messages addressed to an addressee user is greater than the number of output telephone addresses of the server-router, the sender users who will be eliminated are those occurring before a predefined date.

In a second embodiment, the server-router has the means for deleting the telephone address of the oldest sender user to whom the addressee user has not replied.

Thus, in the case wherein the number of messages addressed to the addressee user is greater than the number of output telephone addresses of the server-router, the sender users who will be eliminated are those with the oldest historical precedence.

In a third embodiment, server-router has the means for deleting the telephone address of the sender user to whom the addressee user has replied.

Thus, the server-router releases output telephone addresses.

The server-router according to the invention is more particularly intended to enable an addressee user who is a forum member to receive messages from the forum and to reply to them.

The server-router is characterized in that it uses a common output telephone address for all of the forum messages.

Thus, all of the incoming and outgoing messages between the forum and the particular member pass via a unique telephone address and use as the addressee user either the addressee user (forum member), if they are coming from the server, or the forum, if they are coming from the addressee user.

Preferably, the output telephone addresses of the server-router are present in particular in the form of multiplexing channels.

The server-router is most particularly conceived for exchanging audio messages anonymously. The mobile telephones comprise the sending means for sending in DTMF mode the addressee user's or the forum group's alias and the transmitting means for transmitting the alias in DTMF mode to a server-router.

Preferably, for sending the alias of the addressee user or that of the forum group in DTMF mode, the voice server-router is characterized in that it comprises transmitting means for sending a send request to the sender user's mobile telephone for the alias in DTMF mode. The mobile telephone comprises the data entry means, in particular a keypad.

Thus, the sender user can enter, by means of the mobile telephone keypad, the first letter of the alias of the addressee user and so on. Thus, for example, the alias “musik” will be entered by the sender user in DTMF mode by using the keys with the numbers 68745 in succession.

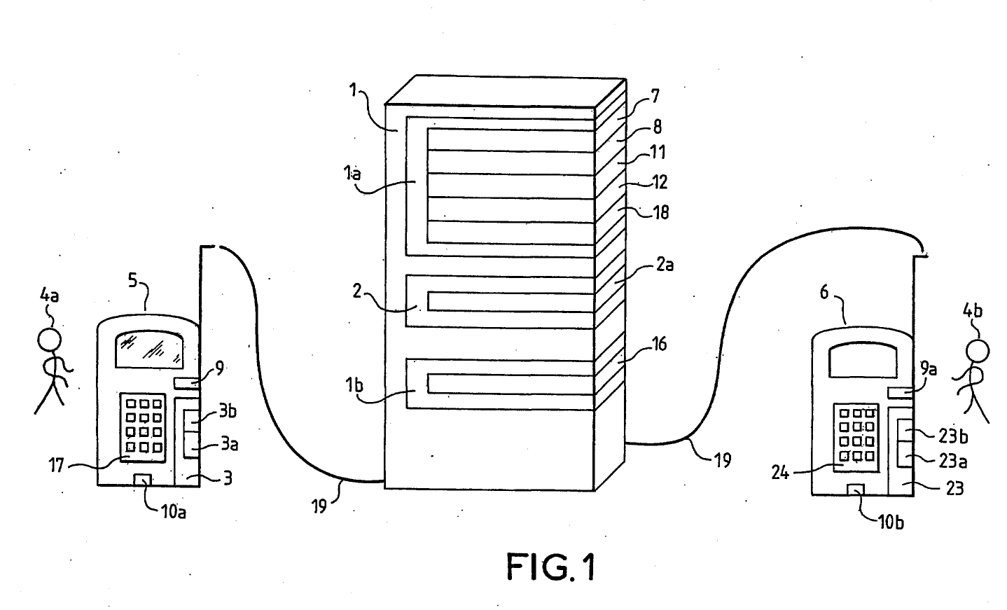

Other characteristics and advantages of the invention will become apparent from a reading of the description of the embodiments of the invention, provided as non-limiting examples and FIG. 1, which graphically represents the system according to the invention.

FIG. 1 represents the system enabling users 4a, 4b of mobile telephones 5, 6 to anonymously exchange, using a dedicated server 1, messages in the form of text or audio, by using simple commands not requiring the use of keywords.

The system according to the invention comprises a dedicated server 1 using pseudonyms (in the following the term “alias” will be used). The dedicated server 1 comprises a text server-router 1a for routing the text messages as well as a voice server-router 1b for routing the audio messages. The system, whose function is based on the use of aliases, makes possible the exchange of messages between users not using the same protocols: SMS, Voix [voice], WAP, Internet, e-mail and other instant messaging systems. One such system thus allows setting up communications gateways between these different protocols and to resolve the problem of their compatibility.

Registration of the Aliases on the Dedicated Server

The aliases used by the users 4a, 4b are, for example, forenames like Giles, John, Christian, etc. They allow the users 4a, 4b to exchange messages anonymously. Whether messages are sent in text mode or in audio mode, the alias used remains the same.

The users 4a, 4b use mobile telephones 5, 6 that comprise sending means 3, 23. Said sending means 3, 23 comprise inserting means 3a, 23a as well as transmitting means 3b, 23b. The mobile telephones 5, 6 of the users 4a, 4b further comprise data entry means 17, 24, in particular a keypad enabling the users 4a, 4b to enter data. When they connect with the dedicated server 1 for the first time over a mobile telephone net 19, the users 4a, 4b transmit their aliases to the dedicated server 1 using the transmission means 3b, 23b contained in their mobile telephones 5, 6. The dedicated server 1 comprises memorizing means 2a for memorizing and storing the aliases transmitted in this fashion in a database 2 for identifying the users 4a, 4b as well as the telephone addresses of the user's 4a, 4b mobile telephones 5, 6.

Sending a Text Message from a Particular Sender User to a Particular Addressee User

To send a text message to an addressee user 4b the sender user 4a uses the sending means 3 contained in the mobile telephone 5. The sending means 3 contained in the mobile telephone 5 of the sender user 4a comprises inserting means 3a for inserting the alias of the addressee user 4b into a message text linked to the text message.

For example, to send the message “The Monday meeting is on” to an addressee user 4b (whose alias is Gilles), the sender user 4a (whose alias is John) enters the following message: “Gilles The Monday meeting is on” using the keypad 17 of his mobile phone 5. In this example, the associated text message is Gilles; in other words, the address user's 4b alias. The sender user 4a uses the sending means 3 contained in his mobile telephone 5, more particularly the transmission means 3b for transmitting the message text (“The Monday meeting is on”) to the server-router 1 together with the text message. The text server-router 1a comprises receiving means 18 for receiving the message transmitted by the sender user 4a. The text server-router further comprises detection means 7 for detecting within the message the message text containing an alias (the alias Gilles) and for searching in the database 2 the telephone address of the mobile telephone 6 of the addressee user 4b (the telephone address of Gilles). The text server-router 1a further comprises the routing means 8 for routing the message text as well as the text message to the addressee user's 4b (Gilles) mobile telephone 6 receiving the text message sent by the sender user 4a (John), without the latter (John) revealing his identity and/or knowing the identity of the addressee user 4b (Gilles) and likewise without the latter (John) using text commands for sending the text message.

Sending an Audio Message by a Particular Sender User to a Particular Addressee User

The sender user 4a can choose to anonymously send an audio message (his recorded voice, for example). In order to send an audio message, the sender user 4a must attach to said audio message a message in DTMF mode containing the addressee user's 4b address. The DTMF mode message contains the alias of the addressee user 4b. The sender user 4a uses the sending means 3 of his mobile telephone 5 to send the alias of the addressee user 4b in DTMF mode. The sender user's 4a mobile telephone 5 further comprises transmitting means 3b for transmitting the alias in DTMF mode to the voice server-router 1b. In order to send the addressee user 4b alias in DTMF mode, the voice server-router 1b comprises transmitting means to send an alias send request in DTMF mode to the mobile telephone 5 of the sender user 4a. the mobile telephone 5 of the sender user 4a comprises data entry means 17, in particular a keypad. Thus, in practice, using the keypad of his mobile telephone 5 the sender user 4a enters the first letter of the addressee user 4b alias and so on. For example, the alias “musik” would be entered by the sender user 4a in DTMF mode by using the keys showing the numbers 68745 in succession. At the time of entering the alias “musik” he will have been careful to verify that this combination is not already assigned because, for example, the world “oupil” has the same DTMF signature.

The sender user 4a transmits the audio message and the associated DTMF message text to a voice server-router 1b. The message is then recorded on the voice server-router 1b and awaits listening.

In order to listen to his messages, the addressee user 4b must call the voice server-router 1b, which will “read” the audio messages by previously adding the name of the sender user 4a and any date sent and time.

By pressing a key defined by the mobile telephone, the addressee user can then respond vocally to the sender user (alias or group).

In an alternative embodiment, the voice server-router 1b sends an SMS alert to the addressee user to notify him that he has an audio message waiting for him.

In further alternative embodiment compatible with the aforesaid one, the addressee user, by reviewing his messages on the Web, sees in the list of messages received: alias of the sender user, the date and time that the audio message was received. Then, by clicking on an icon representing a file attachment, he listens to the audio message received. It is then possible to reply to the sender user by sending him a text message via the Web.

Recognition of Aliases by the Dedicated Server

It is recommended that the dedicated server 1 avoid confusing one alias with a word having the appearance of an alias when it receives a message. For example, the dedicated server 1 must not confuse the addressee alias Gilles with that of Phillip in the following message that John addresses to Gilles: “Gilles You have a meeting with Phillip on Monday.” Two variants are possible to avoid such confusion.

According to a first variant embodiment, the alias is defined by its position in the message, in particular the beginning of the message. Thus, for example, the message: “Gilles Christian You have a meeting with Phillip on Monday” will be interpreted by the dedicated server 1 as containing the instruction to send the message to the telephone addresses of the aliases Gilles and Christian but not to send it to Phillip who is as such an alias in the database 2. In fact, only the aliases Gilles and Christian are located at the beginning of the message. The separator that avoids confusion of the aliases Gilles and Christian is not a comma or any other character but the space between the character . . . s and the character . . . c.

According to a second variant embodiment, the alias is composed by adding a marker to a word such as, in particular an asterisk *. Thus, for example, the message: “*Gilles. You have a meeting with Phillip on Monday” will be interpreted by the dedicated server 1 as containing the instruction to send the message to the telephone address of the alias *Gilles. In fact, by virtue of the insertion of the marker in the message the dedicated server 1 will detect the alias *Gilles, which it will not confuse with the word Phillip which as the appearance of the alias *Phillip.

Sending a Text or Audio Message from a Sender User to the Members of a User Group

The memorizing means 2a of the server-router 1 allow memorizing in the database 2 of the dedicated server 1 of the identifiers and/or the alias of a group of users as well as the addresses of the server hosing the group and/or the telephone addresses of the mobile telephones of the users who are members of the group. The addresses of the server hosting the group are, for example, the addresses of the output channels. In practice, the sender user 4a who wants to send a message to a group of users inserts in his message the group's alias. In this case, the message is routed directly or indirectly by the dedicated server 1 to the users who are members of the group, for whom the dedicated server 1 recognizes telephone address.

Sending a Text or Audio Message from a Sender User to the Members of a Discussion Forum

The sender user 4a who wants to address a message to a discussion forum inserts in his message the forum's alias. In the case wherein the sender user 4a does not insert an alias in his message, his message is considered to have been addressed to participants in the discussion forum that includes the sender user 4a. The message is thus saved by the dedicated server 1 but is not automatically sent to the members of the forum. Nevertheless, the other members of the forum can read it and receive it by connecting the dedicated server 1.

Responding to a Message Received

Concerning the response to a message received, the problem that arises is: a sender user 4a (John) has addressed an anonymous message (using the method described above) to an addressee user 4b (Gilles). the addressee user 4b (Gilles) wants to reply to the sender user 4a (Jean) although he does not know his address.

In a well-known method (this function is currently incorporated by the mobile telephone manufacturers) the mobile telephone 6 of the addressee user 4b (Gilles) comprises memorizing means 10b for memorizing the address of the sender user 4a (Jean) of a message. The mobile telephone 5 of the sender user 4a comprises similar means 10a. In the context of a messaging system known to be anonymous and if the above example is used, the mobile telephone 6 of the addressee user 4b (Gilles) stores the address of the dedicated server 1, since it is the dedicated server 1 that anonymously routed a messages coming from a sender user 4a (Jean) to the addressee user 4b (Gilles). In order to address a reply message to the sender user 4a (Jean), the addressee user 4b (Gilles) has response means contained in his mobile telephone 6. More particularly, the mobile telephone 6 of the addressee user 4b (Gilles) comprises a “reply” command. The mobile telephone 5 of the sender user 4a comprises a similar command 9. By actuating the “reply” command 9a, the addressee user 4b (Gilles) causes the transmission of the reply message that he created to the dedicated server 1, which then routes the reply message to the sender user's (Jean) 4a mobile telephone 5 while preserving the anonymity of the sender user 4a (John) and the addressee user 4b (Gilles). In order to be able to route the reply message created by the addressee user 4b (Gilles) to the sender user 4a (Jean), the dedicated server 1, by virtue of the memorization means 2a, memorized the telephone address of the mobile telephone 5 of the sender user 4a (Jean) as well as the telephone address of the mobile telephone 6 of the addressee user 4b (Gilles).

Reply to a Plurality of Messages Received

An additional problem is presented in the case in which a plurality (and not merely one) of sender users 4a (John, Christian) have anonymously sent different message texts (by using the method described above) to a single addressee user 4b (Gilles). In fact, it is possible to find the address of each sender user 4a (John, Christian) of the original messages to be able then to route the reply messages to the good addresses of the sender users 4a (John, Christian). In order to resolve this problem and enable an addressee user 4b (Gilles) to reply to a plurality of sender users 4a (John, Christian) who have sent one or a plurality of messages addressed to him, the dedicated server 1 comprises a plurality of output telephone addresses. The output telephone addresses of the dedicated server 1 are present in the form of multiplexing channels. The dedicated server 1 further comprises calculation means 11 to assign to the different output telephone addresses to each sender user 4a (John, Christian). The dedicated server 1, by virtue of the memorization means 2a, memorizes the output telephone addresses of the sender users 4a (John, Christian) of the messages it routes, by assigning a defined memory area for each output telephone address. Thus, by actuating the “reply” command 9a, the addressee user 4b (Gilles) causes the transmission of the reply message that he has created to the telephone address of the dedicated server 1 associated with the telephone address of the sender user 4a (John or Christian). The dedicated server 1 then routes the reply message to the sender user 4a (John or Christian) of the original message. In practice, the output telephone addresses are assigned in a cyclical fashion by the dedicated server 1 to the different messages received by a particular addressee user 4b (Gilles). For example, a first message received by Gilles generated by John will be transmitted by the output telephone address N^{o} 1; a second message received by Gilles generated by Christian will be transmitted by the output telephone address N^{o} 2, and so on. The mobile telephone 6 of the addressee user 4b (Gilles) thus proposes to said latter replying to the messages received from the sender users 4a (John and Christian). For example, when the addressee user 4b (Gilles) after having received and read the message coming from the sender user 4a (Christian) is going to press the “reply” command 9a of his mobile telephone 6, his mobile telephone 6 will construct a reply message by inserting into the frame of the message the output telephone address (channel N^{o} 2). More precisely, the number of the output telephone address will be inserted into an “addressee” field of the message frame. Likewise, the telephone address of the addressee user 4b (Gilles) of the message will insert in a “sender” field of the reply message frame. The mobile telephone 6 of the addressee user 4b (Gilles) transmits to the dedicated server 1 the reply message so created by using the sending channel address (channel N^{o} 2). When he receives the reply message (from Gilles), the server-router 1 detects that the reply message is coming form the addressee user 4b (Gilles). It searches its database 2 relative to channel no.2 for the only message that was addressed the addressee user 4b (Gilles) by this channel. The server-router 1 detects in this sole and unique message the address of the sender user 4a (Christian) of this last message. So, it finds the sender user's 4a (Christian's) address.

The means 2a of the dedicated server 1 are such that it memorizes the telephone address of the sender user 4a of the last message that the dedicated server 1 routes via a particular output telephone address. For example, if the dedicated server 1 transmitted two messages via output telephone address N^{o} 2 to Gilles, the first coming from Albert, the second coming from Christian, the dedicated server 1 memorizes only the second and last message; that is, that coming from Christian. Thus, for one same output address, the messages that are eliminated are those that have historical precedence as the oldest. In the example above, if Gilles wishes to reply to Albert, the dedicated server 1 will not be able to find his telephone address. In fact, it will have deleted the data relative to Albert (the oldest message) from the database 2 memory affected by channel N^{o} 2, saving only the data relative to Christian (the most recent message). The number of messages to which an addressee user 4b can reply is thus limited to the number of output telephone addresses of the dedicated server 1. In order not to be subject to this limitation, the solutions consist of “recycling” the output telephone addresses of the dedicated server 1. This solution includes several variants.

In a first variant, the dedicated server 1 comprises the deleting means 12 for deleting, after a defined period of time, the telephone addresses of sender users 4a to whom the addressee user 4b has not replied. Thus, in the case where the number of messages addressed to an addressee user 4b is greater than the number of output telephone addresses of the dedicated server 1, the sender users who will be eliminated are those whose historical precedence exceeds a predefined date. The output telephone addresses are automatically freed after a pre-determined period of time and be re-used by the dedicated server 1 for routing a message from another source to the same addressee user 4b. According to an improved variant of this first variant, if the output telephone address has been used by the addressee user 4b to answer a sender user 4a, then the above-defined period will be discounted from the date of receipt of the reply of the addressee user 4b by the dedicated server 1.

In a second variant, the means 12 of the dedicated server 1 delete the telephone address of the oldest sender user 4a to whom the addressee user 4b has not responded. Thus, in the case where the number of messages addressed to an addressee user 4b is greater than the number of output telephone addresses of the dedicated server 1, the sender users 4a who are eliminated will be those who have the oldest historical precedence. If, for a particular addressee user 4b, the total of the output telephone addresses of the dedicated server 1 is used, the dedicated server 1 uses the output telephone address of the oldest stored message for transmitting a new message to the particular addressee user 4b and the oldest message with the new message in the memory affected by the output telephone address. According to an improved variant to this second variant, if an output address has been used by an addressee user 4b to reply to a sender user 4a, then the date of receipt of the message sent by the sender user 4a will be deemed to be that of the reply message from the addressee user 4b.

In a third variant, the means 12 of the dedicated server 1 delete the telephone address of the sender user 4a to whom the addressee user 4b has replied. Thus, the dedicated server 1 releases output telephone addresses that the addressee user 4b can then use for sending a reply to the sender user 4a.

Replying to a Message in the Context of a Discussion Forum

In the case where the addressee user 4b is a member of a forum and wishes to receive and reply to messages generated by the forum, the dedicated server 1 comprises a common output telephone address for all of the forum messages. The dedicated server 1 thus plays the role of sender user. In effect, all of the incoming and outgoing messages between the dedicated server 1 and the particular forum member pass through a single output telephone address and have as their addressee users: either the addressee user 4b (forum member) if they are coming from the dedicated server 1, or the dedicated server 1, if they are generated by the addressee user 4b. Use of a single output telephone address allows release of other output telephone addresses of the dedicated server 1 that can then be used for transmitting other messages, in particular for transmitting messages between users not participating in the discussion forum.

1. A method enabling users (4a, 4b) of mobile telephones (5, 6) to anonymously exchange text or audio messages by using simple commands not requiring the user of keywords.
Said method is comprised of the following steps:
step I of sending to an addressee user (4b) a text or audio message created by a sender user (4a);
step ii of replying to the sender user (4a) by addressing a reply message to him that is created by the addressee user 4b;
step I of sending to the addressee user (4b) a text or audio message created by a sender user (4a) comprising the following steps:
the step of storing the aliases identifying the users (4a, 4b) and their telephone addresses of the mobile telephones (5, 6) of said users (4a, 4b) in a database (2) of a server-router (1);
the step of inserting, by means of the mobile telephone (5) of the sender user (4a), the alias of the addressee user (4b) in a message text associated with said text or audio message;
the step of transmitting, by means of said sender user's (4a) mobile telephone (5), said message text to said server-router (1) together with the text or audio message;
the step, for said server-router (1), of detecting in said message text the presence of an alias and searching in said database (2) the telephone address of the addressee user's (4b) mobile telephone (6);
the step, for said server router (1), of routing said text message to said addressee user's (4b) mobile telephone (6);
(in such a fashion that the addressee user received the text message sent by the sender user without the latter:
revealing his identity and/or knowing the identity of the addressee user;
using text commands to effect the sending of the text or audio message).

2. A method according to claim 1 such that the memorisation step in a database (2) of a server-router (1) of aliases designating the users (4a, 4b) as well as the telephone addresses of the mobile telephones (5, 6) of said users (4a, 4b) comprises:
the step by the users (4a or 4b) concerned of transmitting his alias to the server-router (1), in particular at the time of establishment of the first connection;

3. A method according to any one of claims 1 or 2 such that the alias is composed by adding a marker such as, in particular, an asterisk *, to a word,
(in such a fashion that, for example. the message: “*Gilles. You have a meeting with Phillip on Monday” is interpreted by the server-router as containing the instruction to send the message to the telephone address of the alias *Gilles).

4. A method according to any one of claims 1 or 2 such that the alias is defined by its position in the message, in particular at the beginning,
(in such a fashion that, for example, the message: “Gilles Christian You have a meeting with Phillip on Monday” is interpreted by the server-router as containing the instruction to send the message to the telephone addresses of the aliases Gilles and Christian; in effect, Gilles and Christian are the aliases found in the database of the server-router and are located at the beginning of the message).

5. A method according to any one of claims 1 to 4 such that the step of memorising the aliases designating the users (4a, 4b) as well as the telephone addresses of the mobile telephones (5, 6) in a database (2) of a server-router (1) comprises:
the step of memorising the identifiers and/or the alias of a group as well as the addresses of the server hosting the group and/or the telephone addresses of the mobile telephones of the users who are members of the group;
(in such a fashion that the messages are routed directly or indirectly by the server-router to the users who are members of the group).

6. A method according to any one of claims 1 to 5, wherein said mobile telephones (5, 6) comprise a “reply” command (9, 9a) which, when actuated, causes the sending of a reply message to the telephone address of the sender of the original message;
said method being characterised in that the step II of replying to the sender user (4a) by addressing to him a reply message created by the addressee user (4b) comprises the following steps:
the step of storing on the server-router (1) the telephone address of the mobile telephone (5) of the sender user (4a) as well as the telephone address of the mobile telephone (6) of the addressee user (4b);
the step of memorising in the mobile telephone (6) of the addressee user (4b) the telephone address of the server-router (1);
(in such a fashion that, when the “reply” command is actuated, the addressee user causes sending of the reply message that he created to the server-router, which in turn routes the reply message to the mobile telephone of the sender user, while preserving the anonymity of the sender user and that of the addressee user).

7. A method according to claim 6, more particularly intended to enable an addressee user (4b) to reply to a plurality of sender users who have sent him one or a plurality of messages;
said method being characterised in that
in order to transmit to the addressee user (4b) those messages coming from the different sender users, the server-router (1) uses different output telephone addresses for each sender user (4a);
the server-router (1) stores the telephone addresses of the sender users of the messages that it routes by assigning a defined memory area for each output telephone addresses;
(in such fashion that, when actuating the “reply” command, the addressee user causes sending of the reply message he created to the telephone address of the server-router associated with the telephone address of the sender user;
in such fashion that the server-router routes the reply message to the sender user of the original message).

8. A method according to claim 7 characterised in that the server-router (1) stores the telephone address of the sender user (4a) of the last message that it routes via a particular output telephone address;
(in such fashion that in the case, wherein the number of messages addressed to an addressee user is greater than the number of output telephone addresses of the server-router, the sender users who are eliminated are those, for a particular output telephone address, have the oldest historical precedence).

9. A method according to any one of claims 7 or 8 characterised in that the server-router (1), after a defined period of time, deletes the telephone addresses of the sender users to whom the addressee user (4b) has not replied,
(in such fashion that in the case, wherein the number of messages addressed to an addressee user is greater than the number of output telephone addresses of the server-router, the sender users who are eliminated are those whose historical precedence exceeds that of a predefined date).

10. A method according to any one of claims 7 to 9, characterised in that the server-router (1) deletes the telephone address of the oldest sender user to whom the addressee user (4b) has not replied;
(in such fashion that in the case, wherein the number of messages addressed to an addressee user is greater than the number of output telephone addresses of the server-router, the sender users who are eliminated are those who have the oldest historical precedence).

11. A method according to any one of claims 7 to 10, characterised in that the server-router (1) deletes the telephone address of the sender user to whom the addressee user (4b) has responded,
(in such fashion that the server-router accordingly releases output telephone addresses).

12. A method according to claim 6, more particularly intended to enable an addressee user (4b) who is a member of a forum to receive messages from the forum and to reply thereto;
said method being characterised in that
in order to transmit to the addressee user (4b) those messages coming from the forum, the server-router (1) uses a common output telephone address for all of the forum messages;
(in such fashion that all of the incoming and outbound messages between the forum and the particular member are passed through a single telephone address and have as their addressee:
either the addressee user (forum member), if they are coming from the server;
or the forum, if they are coming from the addressee user).

13. A method according to any one of claims 6 to 12 such that the output telephone addresses of the server-router (1) are presented in particular in the form of multiplexing channels.

14. A method according to any one of claims 1 to 13 such that in order to exchange audio messages anonymously, said method comprises the following step:
the step of transmitting the alias of the addressee user (4b) of the group or of the forum in DTMF mode;
the step of transmitting the alias to a voice server-router (1b) in DTMF mode.

15. A method according to claim 14, such that in order to transmit the alias of the addressee user (4b) or of the group or of the forum in DTMF mode, said method comprises the following steps:
the step of sending to the mobile telephone (5) of the sender user (4a), from the voice server-router (1b), a send request for the alias in DTMF mode;
the step of entering, by means of the keypad (17) of the mobile telephone of the sender user (4a), the first letter of the alias of the addressee user (4b) and so on,
(in such fashion that, for example, the alias “musik” is entered by the sender user in DTMF mode by using the keys representing the figures 68745 in succession).

16. A system enabling the users (4a, 4b) of mobile telephones (5, 6) to anonymously exchange text or audio messages by using simple commands not requiring the use of keywords;
said system comprising:
storing means (2a) for storing in a database (2) of a server-router (1) the aliases designating the users (4a, 4b) as well as the telephone addresses of the mobile telephones (5, 6) of said users (4a, 4b),
sending means (3, 23) for sending a text or audio message created by a sender user (4a) to an addressee user (4b);
replying means (9, 9a) for addressing a reply message created by the addressee user (4b) to the sender user (4a);
said sending means (3) for sending a text or audio message created by a sender user (4a) to a addressee user (4b) comprising:
inserting means (3a, 23a) for inserting the alias of an addressee user (4b) into a message text associated with said text or audio message;
transmitting means (3b, 23b) for transmitting said message text to said server-router (1) together with the text or audio message,
said server-router (1) comprising:
detecting means (7) for detecting an alias in said message text and searching in said database (2) the telephone address of the mobile telephone (6) of the addressee user (4b);
routing means (8) for routing said message text to said mobile telephone (6) of the addressee user (4b),
(in such fashion that the addressee user receives the message text sent by the sender user without:
revealing his identity and/or not learning the identity of the addressee user;
using text commands to effect sending of the text or audio message).

17. A system according to claim 16, such that in order to store the aliases designating the users (4a, 4b) together with the telephone addresses of the mobile telephones (5, 6) of said users (4a, 4b) in the database (2) of a server-router (1),
the mobile telephone of the users (4a, 4b) concerned comprises transmission means (3b, 23b) for transmitting his alias to the server-router (1), in particular at the time of establishing the first connection.

18. A system according to any one of claims 16 or 17, such that the alias is composed by adding a marker, such as, in particular an asterisk *, to a word,
(in such fashion that, for example, the message: “*Gilles. You have a meeting with Phillip on Monday” is interpreted by the server-router as containing the instruction to send the message to the telephone address of the alias *Gilles).

19. A system according to any one of claims 16 or 17 such that the alias is defined by its position in the message, in particular at the beginning,
(in such fashion that, for example, the message: “Gilles Christian You have a meeting with Phillip on Monday” is interpreted by the server-router as containing the instruction to send the message to the telephone addresses of the aliases Gilles and Christian; in effect, Gilles and Christian are aliases contained in the database of the server-router and are located at the beginning of the message).

20. A system according to any one of the claims 16 to 19, such that
said storage means (2a) storing the identifiers and/or the aliases of a group as well as the addresses of the server hosting the group and/or the telephone addresses of the mobile telephones of the users who are members of the group,
(in such fashion that the messages are routed directly or indirectly by the server-router to the users who are members of the group).

21. A system according to any one of claims 16 to 20; said mobile telephones (5, 6) comprising a “reply” command (9, 9a) which, when actuated, causes sending of a reply message to the telephone address of the sender of the original message;
in order to transmit to the sender user (4a) said reply message created by the addressee user (4b);
said system comprising:
server-router (1) storage means (2a) for storing on the server-router (1) the telephone address of the mobile telephone (5) of the sender user (4a) as well as the telephone address of the mobile telephone (6) of the addressee user (4b);
mobile telephone memorisation means (10a, 10b) for storing in the mobile telephone (6) of the addressee user (4b) the telephone address of the server-router (1),
(in such fashion that, when the “reply” command is actuated, the addressee user causes the sending of the reply message created by him to the server-router, which then routes the reply message to the mobile telephone of the sender user, while preserving the anonymity of the sender user and that of the addressee user).

22. A system according to claim 21, more particularly intended to enable an addressee user (4b) to reply to a plurality of sender users who have addressed one or a plurality of messages to him;
said system being such that the server-router (1) comprises:
a plurality of output telephone addresses, and
calculation means (11) for assigning different output telephone addresses for each sender user (4a), and
storing means (2a) for storing the telephone addresses of the sender users of the messages that it routes, by allocating a defined memory area for each output telephone address,
(in such fashion that, when the “reply” command is actuated, the addressee user causes sending of the reply message that he created to the telephone address of the server-router associated with the telephone address of the sender user;
such that the server-router routes the reply message to the sender user of the original message).

23. A system according to claim 22, such that the server-router (1) storage means (2a) store the telephone address of the sender user (4a) of the last message that it routes via a particular output telephone address,
(in such fashion that in the case, wherein the number of messages addressed to an addressee user is greater than the number of output telephone addresses of the server-router, the sender users who are eliminated are those who, for a particular output address, have the oldest historical precedence).

24. A system according to any one of claims 22 or 23, characterised in that the server-router (1) comprises deleting means (12) for deleting, after a defined period of time, the telephone addresses of sender users to whom the addressee user (4b) has not responded,
(in such fashion that in the case, wherein the number of messages addressed to an addressee user is greater than the number of output telephone addresses of the server-router, the sender users who are eliminated are those whose historical precedence exceeds a predefined date).

25. A system according to any one of claims 22 to 24, characterised in that the server-router (1) comprises deleting means (12) for deleting the telephone address of the oldest sender user (4a) to whom the addressee user (4b) has not replied,
(in such fashion that in the case, wherein the number of messages addressed to an addressee user is greater than the number of output telephone addresses of the server-router, the sender users who are eliminated are those who have the oldest historical precedence).

26. A system according to any one of claims 22 to 25, characterised in that the server-router (1) comprises deleting means (12) for deleting the telephone address of the sender user (4a) to which the addressee user (4b) has replied,
(in such fashion that the server-router accordingly releases output telephone addresses).

27. A system according to claim 21, more particularly intended to enable an addressee user (4b) who is a member of a forum to receive messages from the forum and to reply thereto;
said system being characterised in that the server-router (1) comprises a common output telephone address for all of the forum messages.
(in such fashion that all of the incoming and outbound messages between the forum and the concerned member pass through a single telephone address and have as addressee users:
either the addressee user (forum user), if they are coming from the server;
or the forum, if they are coming from the addressee user.

28. A system according to any one of claims 21 to 27, such that the output telephone addresses of the server-router (1) are presented particularly in the form of multiplexing channels.

29. A system according to any one of claims 16 to 28, such that in order to anonymously exchange audio messages, said mobile telephones of said system comprise:
sending means (3, 23) for sending the alias of the addressee user (4b) or that of the group or of the forum in DMTF mode;
transmitting means (3b, 23b) for transmitting the alias in DTMF mode to a voice server-router (1b).

30. A system according to claim 29, such that for sending in DTMF mode, the alias of the addressee user (4b) or of the group or of the forum,
said voice server-router (1b) comprises transmitting means (16) for sending an alias send request in DTMF mode to the mobile telephone (5) of the sender user (4a);
said mobile telephone (5) comprises data entry means (17), in particular a keypad,
(such that the sender user can enter, using the keypad of his mobile telephone, the first letter of the alias of the addressee user and so on,
in such fashion, for example, that the alias “musik” is entered by the sending user in DTMF mode by using the keys representing the number 68745 in succession).

31. A server-router (1) enabling users (4a, 4b) of mobile telephones (5, 6) to anonymously exchange text or audio messages by using simple commands not requiring the use of keywords;
said server-router (1) comprising:
storage means (2a) for storing in a database (2) aliases of users (4a, 4b) together with the telephone addresses of the mobile telephones (5, 6) of said users (4a, 4b);
said sender user (4a) sending a text or audio message to an addressee user (4b) comprising the alias of the addressee user (4b);
said addressee user (4b) addressing reply message to the sender user (4a);
said server-router (1) further comprising:
receiving means (18) for receiving said message text as well as the text or audio message;
detecting means (7) for detecting the presence of an alias in said message text and searching for the telephone address of the mobile telephone (6) of the addressee user (4b) in the database (2);
routing means (8) for routing said text message to said mobile telephone (6) of the addressee user (4b),
(such that the addressee user receives the text message sent by the sender user without said latter:
revealing his identity and/or learning the identity of the addressee user;
using text commands for effecting sending of the text or audio message).

32. A server-router (1) according to claim 31, such that for storing aliases designating the users as well as the telephone addresses of the mobile telephones (5, 6) of said users (4a, 4b) in a database (2) of the server-router (1), the mobile telephones (5, 6) of the users (4a, 4b) concerned transmit their alias to the server-router (1), in particular at the time of establishing the first connection.

33. A server-router (1) according to any one of claims 31 or 32, such that the alias is composed by adding a marker such as, in particular an asterisk *, to a word,
(in such fashion that, for example, the message: “*Gilles. You have a meeting with Phillip on Monday” is interpreted by the server-router as containing the instruction to send the message to the telephone address of the alias *Gilles).

34. A server-router (1) according to any one of claims 31 or 32 such that the alias is defined by its position in the message, in particular at the beginning,
(in such fashion that, for example, the message: “Gilles Christian You have a meeting with Phillip on Monday” is interpreted by the server-router as containing the instruction to send the message to the telephone addresses of the aliases Gilles and Christian; in effect, Gilles and Christian are aliases contained in the database of the server-router and are located at the beginning of the message).

35. A server-router (1) according to any one of the claims 31 to 34, such that
said storage means (2a) storing the identifiers and/or the aliases of a group as well as the addresses of the server hosting the group and/or the telephone addresses of the mobile telephones of the users who are members of the group,
(in such fashion that the messages are routed directly or indirectly by the server-router to the users who are members of the group).

36. A server-router (1) according to any one of claims 31 to 35; said mobile telephones (5, 6) comprising a “reply” command which, when actuated, causes sending of a reply message to the telephone address of the sender of the original message;
said server-router (1) being characterised in that it comprises storage means (2a) for storing on the telephone address of the mobile telephone (5) of the sender user (4a) as well as the telephone address of the mobile telephone (6) of the addressee user (4b);
the mobile telephone (6) of the addressee user (4b) memorising the telephone address of the server-router (1),
(in such fashion that, when the “reply” command is actuated, the addressee user causes the sending of the reply message created by him to the server-router, which then routes the reply message to the mobile telephone of the sender user, while preserving the anonymity of the sender user and that of the addressee user).

37. A server-router (1) according to claim 36, more particularly intended to enable an addressee user (4b) to reply to a plurality of sender users who have addressed one or a plurality of messages to him;
said server-router (1) being such that it comprises:
a plurality of output telephone addresses, and
calculation means (11) for assigning different output telephone addresses for each sender user (4a), and
storing means (2a) for storing the telephone addresses of the sender users of the messages that it routes, by allocating a defined memory area for each output telephone address,
(in such fashion that, when the “reply” command is actuated, the addressee user causes sending of the reply message that he created to the telephone address of the server-router associated with the telephone address of the sender user;
such that the server-router routes the reply message to the sender user of the original message).

38. A server-router (1) according to claim 37, such that the server-router (1) storage means (2a) store the telephone address of the sender user (4a) of the last message that it routes via a particular output telephone address,
(in such fashion that in the case, wherein the number of messages addressed to an addressee user is greater than the number of output telephone addresses of the server-router, the sender users who are eliminated are those who, for a particular output address, have the oldest historical precedence).

39. A server-router (1) according to any one of claims 37 or 38, characterised in that the server-router (1) comprises deleting means (12) for deleting, after a defined period of time, the telephone addresses of sender users to whom the addressee user (4b) has not responded,
(in such fashion that in the case, wherein the number of messages addressed to an addressee user is greater than the number of output telephone addresses of the server-router, the sender users who are eliminated are those whose historical precedence exceeds a predefined date).

40. A server-router (1) according to any one of claims 37 to 39, characterised in that it comprises deleting means (12) for deleting the telephone address of the oldest sender user (4a) to whom the addressee user (4b) has not replied,
(in such fashion that in the case, wherein the number of messages addressed to an addressee user is greater than the number of output telephone addresses of the server-router, the sender users who are eliminated are those who have the oldest historical precedence).

41. A server-router (1) according to any one of claims 37 to 40, characterised in that the server-router (1) comprises deleting means (12) for deleting the telephone address of the sender user (4a) to which the addressee user (4b) has replied,
(in such fashion that the server-router accordingly releases output telephone addresses).

42. A server-router (1) according to claim 36, more particularly intended to enable an addressee user (4b) who is a member of a forum to receive messages from the forum and to reply thereto;
said system being characterised in that the server-router (1) comprises a common output telephone address for all of the forum messages.
(in such fashion that all of the incoming and outbound messages between the forum and the concerned member pass through a single telephone address and have as addressee users:
either the addressee user (forum user), if they are coming from the server;
or the forum, if they are coming from the addressee user.

43. A server-router (1) according to any one of claims 36 to 42, such that the output telephone addresses of the server-router (1) are presented particularly in the form of multiplexing channels.

44. A server-router (1) according to any one of claims 31 to 43, more particularly conceived in order to anonymously exchange audio messages; said mobile telephone comprising sending means (3, 23) for sending the alias of the addressee user (4b) or that of the group or of the forum in DTMF mode and the transmitting means (3b, 23b) for transmitting the alias to a server-router (1) in DTMF mode.
transmitting means (3b, 23b) for transmitting the alias in DTMF mode to a voice server-router (1b).

45. A system according to claim 44, such that for sending in DTMF mode, the alias of the addressee user (4b) or of the group or of the forum,
said voice server-router (1) being characterised in that it comprises transmitting means (16) for sending an alias send request in DTMF mode to the mobile telephone (5) of the sender user (4a);
said mobile telephone (5) comprises data entry means (17), in particular a keypad,
(such that the sender user can enter, using the keypad of his mobile telephone, the first letter of the alias of the addressee user and so on,
in such fashion, for example, that the alias “musik” is entered by the sending user in DTMF mode by using the keys representing the number 68745 in succession).
